(19) United States
(12) Patent Application Publication
(10) Pub. No.: US 2012/0009382 A1
(43) Pub. Date: Jan. 12, 2012

(54) GUARD SUBSTRATE FOR OPTICAL ELECTROMOTIVE FORCE EQUIPMENT, AND ITS PRODUCTION PROCESS

(75) Inventors: Yasukazu KISHIMOTO, Tokyo (JP); Toru Yoshida, Yamaguchi (JP)

(73) Assignee: TOSOH F-TECH, INC., Shunan-city (JP)

(21) Appl. No.: 12/830,716

(22) Filed: Jul. 6, 2010

(51) Int. Cl. B32B 3/30; B32B 38/14; B32B 37/24; B32B 17/10; B29C 65/00

(52) U.S. Cl. 428/119; 428/172; 156/307.1; 156/245; 156/277

(57) ABSTRACT

The object of the invention is to provide a protective sheet for photovoltaic apparatus best-suited to build up a photovoltaic apparatus having higher light efficiency than could be achieved with conventional structure.

The protective sheet for photovoltaic apparatus comprises a transparent substrate, and a transparent resin layer located on the surface of the transparent substrate and having fine convexities and concavities. The transparent resin of the transparent resin layer has a refractive index equal to or less than that of the transparent substrate.

### BACKGROUND OF THE INVENTION

1. Field of the Invention

The present invention relates to a protective sheet for photovoltaic apparatus and its production process, and more specifically to a protective sheet for photovoltaic apparatus having a limited reflectivity to extraneous light and an improved lighting efficiency, and its production process.

2. Description of the Prior Art

A photovoltaic apparatus capable of generating photovoltage upon receipt of light has been used typically with photovoltaic power generation systems drawing attention as a substituent energy source adapted to provide a certain solution to environmental problems with existing power generation processes involved in thermal power plants, hydropower plants, atomic power plants or the like. A typical photovoltaic power generation system is generally called a solar battery, and one of grave problems with it is now low power generation efficiency. Although many methods have so far been studied to improve power generation efficiency, the focus has been mainly on improvements in the light/electricity conversion efficiency (photovoltaic conversion efficiency) of solar battery cells themselves.

A solar battery module here includes a surface protective member such as glass or a transparent resin film on the surface of each cell for the purpose of protecting cells; however, action taken for boosting up the power generation efficiency of that portion has been still less than satisfactory. Usually, nothing significant has been applied on that transparent protective member. With a solar battery module using a conventional protective member such as a glass sheet, about 3 to 4% of sunlight will be reflected off at the surface. This reflected light, because of making no contribution to power generation at all, has become one grave factor responsible for a lowering of the power generation efficiency of the solar battery module.

JP(A)9-191115 (Patent Publication 1) shows a solar battery module wherein a fibrous inorganic compound-impregnated transparent organic polymer resin (for instance, EVA) having convexities and concavities at a pitch of given magnitude is located at a light entrance side of a photovoltaic device thereby staving off a problem that reflected light arrives at neighboring houses or the ground, making people out there feel dazed and uncomfortable, leaving wrinkles in the transparent organic polymer less noticeable thereby preventing deposition of dirt on the surface, and allowing for extended outdoor use.

However, the convexity/concavity structure shown in Patent Publication 1 is to prevent glaring and deposition of dirt, with no care taken whatsoever of how to stay off surface reflection for the purpose of improving power generation efficiency. Patent Publication 1 also shows that to provide convexities/concavities on the surface of the covering material, the transparent organic polymer compound is impregnated with the fibrous inorganic compound, and there is the specific mention of glass fiber unwoven fabrics, glass fiber woven fabrics, glass fillers, etc. However, there is not only the need of providing a step of dispersing and impregnating these fibers in the associated resin, but also the need of strictly controlling the degree of dispersion in such a way as to place it in an allowable range, ending up with difficulty in mass production and added-up production costs. Furthermore, in order to allow those fibers to be used over an extended period, some primer treatment is needed to make sure sufficient adhesion power between them and the resin material, again resulting in an increased steps count.

JP(A)2008-260654 (Patent Publication 2) shows a method wherein thin films having a high refractive index and a low refractive index are stacked or laminated in combination on both or one side of a cover glass, thereby minimizing reflection in a wavelength range wherein a solar battery cell takes an effective light/electricity conversion action and, hence, increasing the quantity of transmitted light.

With the method of Patent Publication 2, however, effects on improvements in prevention of reflection of light at the surface itself, and on light having a small angle of incidence, are less expectable because the effect on prevention of reflection is achievable through the combination of thin film layers having different refractive indices.

### LISTING OF THE PRIOR ART PUBLICATIONS

### Patent Publications

Patent Publication 1: JP(A)9-191115
Patent Publication 2: JP(A)2008-260654

### SUMMARY OF THE INVENTION

### Object of the Invention

The present invention has for its object to provide a protective sheet for photovoltaic apparatus best-suited to build up a photovoltaic apparatus having higher light/electricity conversion efficiencies than could be achieved with conventional structures, and its production process.

### Means for Accomplishing the Object

Glasses or transparent resin films used so far for the protection of solar battery cells have a refractive index of 1.5 or greater, and have offered a problem in that there is a high surface refractive index because there is a large refractive index difference with the atmosphere (air). Supposing here that the refractive index of air is 1.00 and the refractive index of glass is 1.52, the angle of incidence of light and the reflectivity of light at the glass surface have such relations as shown in the following table. For the angles of incidence tabulated below, it is to be noted that the angle of incidence of zero degree is defined by the normal direction to the glass plane.

TABLE 1

| Angle of Incidence (°) | 0 | 15 | 30 | 45 | 60 | 75 | 90 |
|---|---|---|---|---|---|---|---|
| Reflectivity (%) | 4.3 | 4.7 | 6.1 | 9.7 | 18 | 41 | 0 |

As can be seen from Table 1, glass reflects at least 4% of light even upon vertical incidence (0°).

Obliquely incident light is more reflected; for instance, at an angle of incidence of 70 degrees, there is a reflectivity reaching 30% or greater. For this reason, care must be taken of reflection of light obliquely incident on the sheet surface in particular.

To accomplish the aforesaid object, the present invention is embodied as follows.

(1) A protective sheet for photovoltaic apparatus, comprising a transparent resin layer having a convexity/concavity structure on the surface of a transparent substrate located at a light reception site, wherein said transparent resin layer has a refractive index equal to or lower than that of said transparent substrate.

(2) The protective sheet for photovoltaic apparatus according to (1) above, wherein said transparent substrate is formed of glass.

(3) The protective sheet for photovoltaic apparatus according to (1) above, wherein said transparent resin layer is formed of either a resin or a resin and an inorganic material.

(4) The protective sheet for photovoltaic apparatus according to (1) above, wherein a region, in which a tangent to a convex surface forming a part of said convexity/concavity structure makes an angle of 60 degrees or less with a normal to a substrate surface, has an area accounting for 5% or greater of the whole area of said convexity/concavity structure.

(5) The protective sheet for photovoltaic apparatus according to (1) above, wherein said convexity/concavity structure is configured such that a sectional shape in a normal direction to said transparent substrate is approximate to either a part of a circle or a triangle wherein a bottom size is 200 nm to 1,000 μm as expressed in terms of diameter, and a convexities count is 1 to 2.5×10⁹ per 1 cm².

(6) The protective sheet for photovoltaic apparatus according to (1) above, wherein said convexities and concavities have an average size of 2 mm or less.

(7) The protective sheet for photovoltaic apparatus according to (1) above, wherein said transparent resin layer comprises a thermosetting or photo-curing resin.

(8) A process for producing a protective sheet for photovoltaic apparatus, comprising steps of:

stacking or laminating on a transparent substrate located at a light reception site a transparent resin having a refractive index equal to or lower than that of said transparent substrate,

configuring the surface of said transparent resin layer in such a way as to have fine convexities and concavities, and

curing said transparent resin layer either during or after said configuring so that a structure having fine convexities/concavities is formed on the surface of said transparent resin layer.

(9) The protective sheet production process according to (8) above, wherein the surface of said transparent resin layer is pressed against a combination of a mold having fine convexities/concavities and a thread-form member or continuously engaged with or scraped off by a rigid member having projections or claws to form concavities, thereby providing a convexity/concavity texture.

(10) The protective sheet production process according to (8) above, wherein after lamination of said transparent resin, convexities/concavities are provided by means of photo-masking or photo-molding.

(11) The protective sheet production process according to (8) above, wherein said transparent resin is laminated by printing in a pattern having fine convexities/concavities to provide a convexity/concavity structure thereto.

(12) The protective sheet production process according to (8) above, wherein said transparent resin layer comprises a thermosetting resin or a photo-curing resin.

### Advantages of the Invention

According to the invention, the transparent resin having a low refractive index is used so that there can be a lower reflectivity than could be achieved with glass or a polymer film such as PET/polyethylene. In addition, the provision of the stereoscopic texture structure having fine convexities/concavities (hereinafter often called as the fine convexity/concavity structure) makes sure a further lowering of reflectivity. It is thus possible to provide a protective sheet for photovoltaic apparatus best-suited to set up photovoltaic apparatus higher in light/electricity conversion efficiency than conventional structures, and its production process.

With the inventive production process for a protective sheet for photovoltaic apparatus, it is possible to provide a continuous production of the fine convexity/concavity structure in simple operation yet at lower costs, proffering great advantages for mass production of the protective sheet for photovoltaic apparatus.

### BRIEF EXPLANATION OF THE DRAWINGS

FIG. 1 is illustrative in schematic of one embodiment of the protective sheet for photovoltaic apparatus according to the invention.

FIG. 2 is illustrative in schematic of another embodiment of the protective sheet for photovoltaic apparatus according to the invention.

FIG. 3 is illustrative in schematic of the principles of the protective sheet for photovoltaic apparatus according to the invention.

FIG. 4 is illustrative in schematic of the principles of the protective sheet for photovoltaic apparatus according to the invention.

### MODE FOR CARRYING OUT THE INVENTION

The inventive protective sheet for photovoltaic apparatus comprises a transparent substrate located at the light reception site of a photovoltaic apparatus, and a transparent resin layer provided on the surface of the transparent substrate wherein the transparent resin layer has fine convexities and concavities. One embodiment of the invention is now explained with reference to the drawings.

FIG. 1 is illustrative of one exemplary arrangement of the inventive protective sheet for photovoltaic apparatus. As shown in FIG. 1, the protective sheet for photovoltaic apparatus comprises a transparent substrate 101 and a texture structure 102 provided on the transparent substrate, which structure is formed of a transparent resin and has fine convexities and concavities.

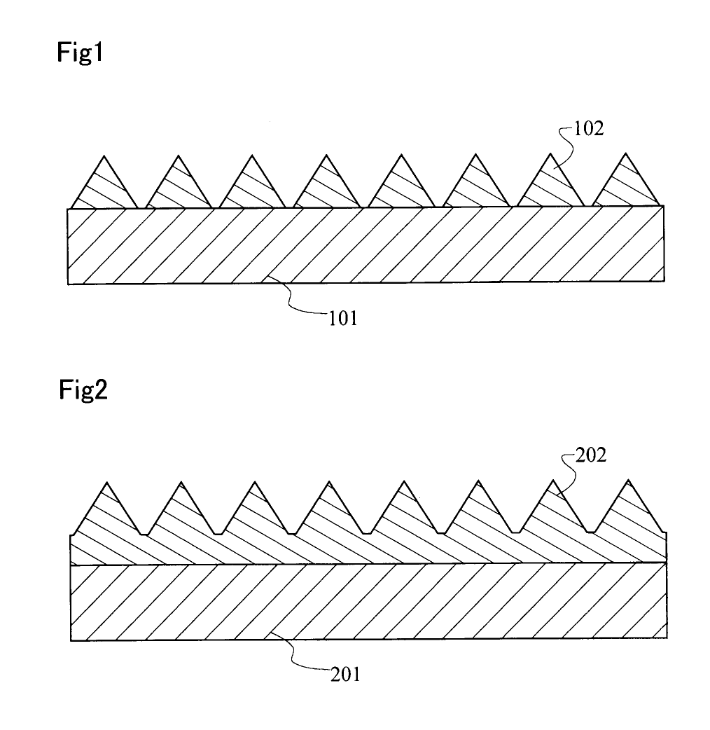

FIG. 2 is illustrative of another exemplary arrangement of the inventive protective sheet for photovoltaic apparatus. As shown in FIG. 2, the protective sheet for photovoltaic apparatus comprises a transparent substrate 201 and a transparent resin layer 202 provided on the transparent substrate, which structure is formed of a transparent resin and has a fine convexity/concavity texture structure.

The fine convexity/concavity texture provided on the transparent substrate may be not only of an independent structure as shown in FIG. 1 but also of a structure wherein, as shown in FIG. 2, a texture having fine convexities and concavities is formed on the upper portion of the transparent resin layer.

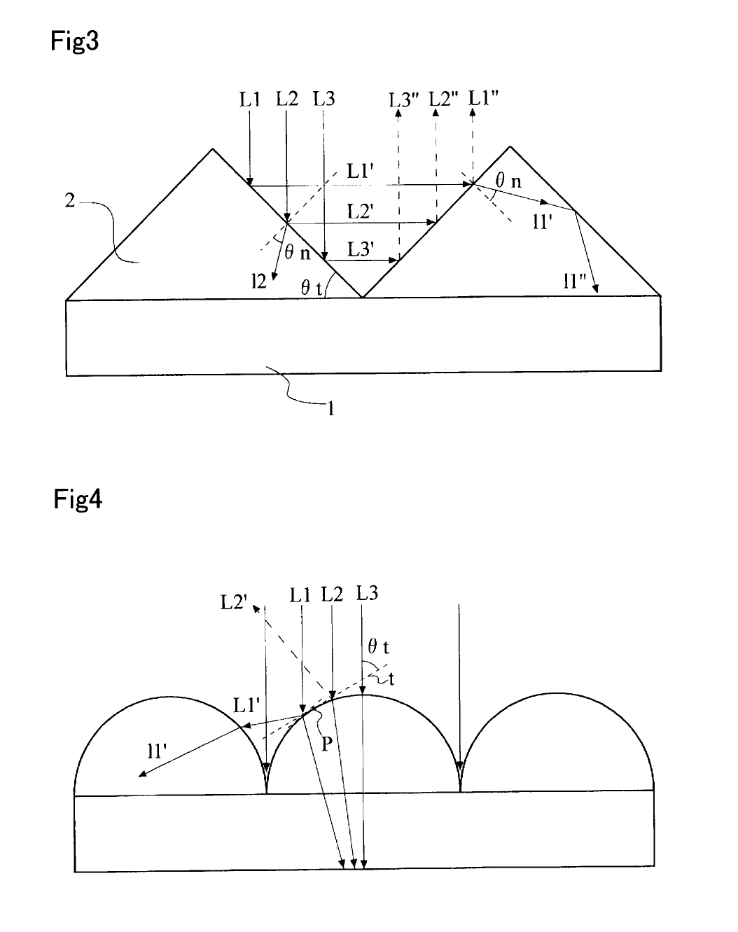

First of all, the principles of the invention are now explained. FIGS. 3 and 4 are illustrative in schematic of the protective sheet for photovoltaic apparatus, showing the principles of the invention. In the inventive fine convexity/concavity structure, each or the convexity is configured to have a sectional shape approximate to either a part of a circle or a triangle. Therefore, convexities of a rectangular shape in longitudinal or cross section are factored out. Referring to FIG. 3, the inventive fine convexity/concavity structure 2 is provided on a substrate 1. For an easy understanding of explanation, the fine convexities and concavities of this structure are each assumed to have a triangular shape in section.

Suppose now that the substrate is irradiated with light rays L1, L2, L3 from the vertical direction. As the light rays L1, L2, L3 arrive at the slants of each convexity of the structure 2, some transmit through and some are reflected off. The reflectivity here is assumed to be 4%. Referring here to the light ray L2, transmitted light l2 is a portion of incident light L2 out of which reflected light L2′ is take: the light ray L2 enters the fine convexity/concavity structure 2 while deflected at just an angle θn depending on the refractive index n of the material of the structure 2, arriving at a cell (not shown) through the substrate 1.

On the other hand, as reflected light L1′, L2′, L3′ are incident on the adjacent convexity, some turn into reflected light L1″, L2″, L3″ that are in turn diffused out and dissipated off. Here incident light l1′ for the reflected light L1″ incident on that adjacent convexity is deflected depending on the refractive index θn as mentioned above, and further reflected at other interface, turning into reflected light l1″ that in turn arrives at a cell through the substrate. Although not shown, a portion of the incident light l1′ is diffused out at that interface as mentioned above. Likewise, other reflected light L2′, L3′ are incident on the adjacent convexity, some arriving at the cell.

Thus, the provision of the fine convexity/concavity structure on the surface of the substrate enables some of reflected light that has been diffused out and dissipated off so far in the art to be entrapped and guided up to the cell, contributing to photovoltaic conversion energy and, hence, resulting in improvements in power generation efficiency. While the structure of triangular shape in section with θt=45° has here been described for an easy understanding of explanation, it is here to be noted that as the angle of incidence of light rays is 45°, it is hard to achieve the effect of the aforesaid structure on efficiency improvements. Accordingly, when the convexities of triangular shape in section are used, they must be designed to have the optimum angle in consideration of installation environments.

The structure having fine semicircular convexities/concavities is now explained with reference to FIG. 4. As shown in FIG. 4, the inventive structure 2 having fine convexities/concavities is provided on a substrate 1. In this exemplary structure having fine convexities/concavities, semicircular convexities are located in proximate and contact relations.

Suppose now that the substrate 1 is irradiated with light rays L1, L2, L3 from the vertical direction. As the light rays L1, L3, L3 arrive at the curved surface of each convexity of the structure 2, some transmit through and some are reflected off. Of tangents to each convexity of the structure 2, the one that makes an angle θt of 60 degrees with the normal to the substrate surface is represented by t, and the point of intersection of the tangent t with the curved line of the convexity is represented by P.

Referring now to the light ray L1 incident on an area where the angle that the tangent makes with the normal is smaller than that at point P, transmitted light l1 is a portion of incident light L1 out of which reflected light L1′ is taken: it enters the fine convexity of the structure 2 while deflected at just an angle θn depending on the refractive index of the material of the structure 2, arriving at a cell (not shown) through the substrate 1. On the other hand, the reflected light L1′ reenters the adjacent convexity of the structure 2 while deflected at just an angle θn with the exclusion of reflected light, arriving at the cell through the substrate 1. It is here to be noted that the transmitted light l1, l2, l3 incident on the spherical surface are deflected in such a way as to converge on a specific focus.

Referring then to the light ray L2 incident on an area where the angle that the tangent makes with the normal is greater than that at point P, the transmitted light l2 that is a portion of the incident light L2 out of which the reflected light L2′ is taken enters each convexity of the structure 2 while deflected at just an angle θn depending on the refractive index of the material of the structure 2, arriving at a cell (not shown) through the substrate 1. On the other hand, the reflected light L2′ will be dissipated off without reentering the convexity of the structure 2 because it is reflected off at an upward angle. While this embodiment has been explained with reference to light from the vertical direction to the substrate surface, it is to be noted that light obliquely incident on the substrate surface may often reenter the convexity/concavity structure even in the area where the angle that the tangent makes with the normal is larger than that at point P. However, it is more likely that the reflected light is dissipated off without reentrance in the area where the angle that the tangent makes with the normal is greater than that at point P than in the area where that angle is smaller.

Thus, the provision of the structure having fine, curved convexities/concavities, too, enables reentrance of a portion of reflected light, contributing to effective use of reflected light. The curved convexity/concavity structure is much more reduced than the triangular convexity/concavity structure in terms of the number of surfaces parallel with or vertical to a variety of incident light, making efficiency less dependent on incident light.

The fine convex/concave texture is not limited to such geometrical shapes as quadrangular pyramid, cone and hemisphere shapes: it may be configured into various shapes such as cylindrical and polygonal shapes. If vertical or slanting surfaces are imparted to the texture, then the angle of oblique incidence of light can be made apparently small, resulting in improved light-collection efficiencies. For this reason, the convexity/concavity structure of the invention is preferably configured such that the section in the normal direction to the substrate surface has a shape approximate to either a part of a circle or a triangle. In other words, the convexity/concavity structure is configured into a contour shape obtained by cutting out a part of a circle, or a shape approximate to a conical shape. Such shapes are easy to process, proffering advantages also in view of production processes.

According to the invention, it has been found that when the slants of each convexity of the convexity/concavity structure have a portion whose angle of inclination is 60 degrees or less on condition that the angle of the substrate in the normal direction is 0, the convexity/concavity structure works more effectively because the light reflected off at those slants strike upon the adjacent slants, providing refracted light. Therefore, it is preferable that the surfaces forming the fine convexities of the convexity/concavity structure includes, at a constant proportion, portions where the angles that the tangents make with the normal to the substrate surface are 60 degrees or less. More specifically, it is preferable that the area of the portions where those angles are 60 degrees or less accounts for 5% or greater, especially 20% or greater, and more especially 30% or greater of the whole area of the fine convexity/concavity structure. Why the lower limit is set at 5% is that given a trapezoidal convexity/concavity structure having at both ends slants accounting for 2.5% of the whole area, there could be an about 20% increase in the quantity of incident light with an at least 0.01% gain increase.

Each or the convexity forming a part of the inventive fine convexity/concavity structure may also be configured into a shape in section approximate to a part of a circle, i.e., a shape obtained by cutting out a part of a sphere. Usually, the formed convexity is often approximate to a deformed sphere, not a true sphere; it is difficult to make a direct estimation of such a shape. For this reason, the convexity is preferably estimated supposing that it is approximate to a part of a sphere. For approximation, for instance, image analysis may be implemented with the replacement of the convexity by a part of a circle having the same area in section or a part of a circle having the most approximate contour shape. The same is true of the approximation of the convexity to a triangular shape in section such as a triangular pyramid shape.

The relation between the radius of curvature A of a convexity approximate to a part of a sphere and the radius B of a circle approximate to the cut section is given by

B≧A/2

The radius of curvature A of the convexity is understood to mean that of the sectional shape of the convexity approximate to a part of a circle as mentioned above, and the approximate circle of the cut section is understood to mean the approximate shape of a portion obtained by cutting out a part of a sphere. This portion is approximate to a circle too: it is defined as an approximate circle. It is then preferable that the radius B of the approximate circle is at least half as long as the radius of curvature A; that is, it satisfies the aforesaid formula.

While there is no particular limitation on the size of the fine convexity/concavity structure, it is understood that as average height size grows than 2 mm, obliquely incident light may possibly do optical damage to it. Individual size may allow for variations. As the size of the fine convexity/concavity texture is less than the wavelength of light, it causes the refractive index to change continuously, giving rise to an optical effect where there is no interface having a refractive index difference.

There is no particular limitation on individual convexity (dot or dimple) size: it may be properly determined while taking into account the viscosity and thixotropy of the resin, how to form the resin, and conditions under which the resin is to be formed. More specifically, when the cross section is replaced by or approximate to a circle, the size is adjusted between preferably 200 nm and 1,000 μm, and more preferably 200 nm to 1,000 nm in terms of diameter. Although there is no particular limitation on the dot-to-dot distance, it is desired that the distance be 0 to about half as long as the dot diameter. Most desirously, the dot-to-dot distance should be zero; that is, there is no gap between dots.

Although any desired number of convexities or concavities may be used in the fine convexity/concavity structure, it is desired that there be a given number of convexities or concavities provided to boost up light-collection efficiency. More specifically, the convexities or concavities count is preferably 1 to 2.5×10⁹, and more preferably 1×10⁸ to 2.5×10⁹ per 1 cm². The convexities and concavities may be located in regular order or at random. The convexities and concavities, if located in regular order, may be arranged in a grid or honeycomb matrix.

For the transparent substrate forming a part of the inventive protective sheet for photovoltaic apparatus, glass materials, resin materials or any other materials may be used, if they have given strength and light transmittance, can be provided with the fine convexity/concavity structure to be described later, and have a function of protecting photovoltaic apparatus such as solar battery cells. With respect to all wavelengths of 400 to 1,100 nm, the transparent substrate should preferably have a light transmittance of 80% or greater, and especially 90 or greater in terms of integrated value (weighted mean). Alternatively, the transparent substrate may have the aforesaid light transmittance in a wavelength zone contributing primarily to power generation in view of the performance of power plants.

No particular limitation is imposed on the glass material for the transparent substrate; a suitable selection may be made from among soda lime silica glass materials that have generally been used in the art and possess properties meeting the demand. There are a variety of glass products having a variety of properties available in a variety of applications. Optionally, glasses having other compositions, for instance, silica glass and borosilicate glass may be used too.

The resin material for the transparent substrate, for instance, includes acryl, polycarbonate, polystyrene, vinyl chloride, and polyethylene terephthalate. That resin material may be the same as the resin of which the fine convexity/concavity structure to be described later is formed.

The inventive fine convexity/concavity structure is formed of a transparent resin material, and has a light transmittance equivalent to that of the aforesaid substrate. Preferably, the light refractive index of the resin material should be less than that of glass. More specifically, the refractive index n should be 1.50 or less, preferably 1.45 or less, more preferably 1.42 or less, and even more preferably 1.40 or less on a 589.3 nm wavelength D-line basis. As the refractive index becomes low, it reduces reflection at an air interface, resulting in an increased quantity of incident light and, hence, boosting up light/electricity conversion efficiencies.

There is no particular limitation on the resin material used; use may be made of any desired resin that has given strength and light transmittance, can be provided with the fine convexity/concavity structure, and has a function of protecting solar battery cells. For instance, use may be made of acryl resin, epoxy resin, PC (polycarbonate), TAC (triacetyl cellulose), PET (polyethylene terephthalate), PVA (polyvinyl alcohol), PVB (polyvinyl butyral), PEI (polyether imide), polyester, EVA (ethylene-vinyl acetate copolymer), PCV (polyvinyl chloride), PI (polyimide), PA (polyamide), PU (poly-urethane), PE (polyethylene), PP (polypropylene), PS (polystyrene), PAN (polyacrylonitrile), butyral resin, ABS (acrylonitrile-butadiene-styrene copolymer), fluoro-resin such as ETEF (ethylene-tetrafluoroethylene copolymer) and PVF (polyvinyl fluoride), silicone resin, or resin compositions comprising these resins and having thermosetting capability or ultraviolet or other activating energy curing capability imparted to them.

In consideration of ease of production and processing, etc., preference is given to ultraviolet or other activating energy radiation curing resins or thermosetting resins.

For the activating energy radiation curing resin, preferably the ultraviolet curing resin, for instance, there is the mention of silicone resin, acryl resin, unsaturated polyester resin, epoxy resin, oxetane resin and polyvinyl ether resin which may be used alone or in admixture of two or more. Preferably, these resins are fluorinated.

For the thermosetting resin, for instance, there is the mention of epoxy resin, melamine resin, urea resin, urethane resin, polyimide resin, and inorganic polymers such as silazane resin and silicone resin, which may be used alone or in admixture of two or more. Preferably, these resins are fluorinated.

In the invention, use may also be made of thermoplastic resins, among which fluorine-containing thermoplastic resins are preferred. For the fluorine-containing thermoplastic resins, there is the mention of aliphatic fluororesin such as ETFE, THV made by Sumitomo 3M Co., Ltd., and KYNAR made by Arkema, and alicyclic fluororesin such as Teflon AF made by Du Pont and CYTOP made by AGC.

Furthermore, the aforesaid activating energy radiation curing polymerization type acryl resin should preferably contain a fluorine group. The incorporation of a fluorine group in the acryl resin allows its refractive index to be easily lowered. Fluorination also makes water repellency so high that the function of preventing the resin from being stained can be enhanced, ending up with prevention of deterioration over time of light/electricity conversion efficiencies.

For the acryl resin, acrylic acid or methacrylic acid polymers or copolymers are preferred. Such polymers, for instance, include polymethyl methacrylate, poly-n-butyl acrylate, poly-t-butyl-acrylate, poly-t-butyl-methacrylate, polystearyl methacrylate, poly-trifluoroethyl methacrylate, polycyclohexyl methacrylate, polyphenyl methacrylate, polyglycidyl methacrylate, and polyallyl methacrylate.

The monomers preferable for the formation of the polymer or copolymer, for instance, include methyl methacrylate, methyl acrylate, ethyl methacrylate, ethyl acrylate, propyl methacrylate, propyl acrylate, butyl methacrylate, butyl acrylate, glycidyl methacrylate, glycidyl acrylate, methoxyethyl methacrylate, methoxyethyl acrylate, propanone methacrylate, butanone methacrylate, and amyl acrylate.

The preferable fluorinated monomers, for instance, include trifluoroethyl acrylate, trifluoroethyl methacrylate, tetrafluoropropyl acrylate, tetra-fluoropropyl methacrylate, hexafluoroisopropyl acrylate, hexafluoroisopropyl methacrylate, hexafluorobutyl methacrylate, heptafluorobutyl acrylate, penta-fluoropropyl methacrylate, and pentafluoropropyl acrylate.

The preferable fluorinated acryl resins, for instance, include poly(1,1,1,3,3,3-hexyluoroisopropyl acrylate) (n=1.375; Tg=−23), poly(2,2,3,3,4,4,4-heptafluorobutyl acrylate)(n=1.377; Tg=−30), poly(2,2,3,3,4,4,4-heptafluorobutyl methacrylate)(n=1.383; Tg=6.5), poly(2,2,3,3,3-pentafluoropropyl acrylate)(n=1.389; Tg=−26), poly(1,1,1,3,3,3-hexafluoroisopropyl methacrylate) (n=1.39; Tg=56), poly(2,2,3,4,4,4-hexafluorobutyl acrylate)(n=1.394; Tg=−22), poly(2,2,3,4,4,4-hexafluorobutyl methacrylate), poly(2,2,3,3,3-pentafluoropropyl methacrylate) (n=1.395; Tg=70), poly(2,2,2-trifluoroethyl acrylate)(n=1.411; Tg=−10), poly(2,2,3,3-tetrafluoropropyl acrylate (n=1.415; Tg=−22), poly(2,2,3,3-tetrafluoropropyl methacrylate)(n=1.417; Tg=68), and poly(2,2,2-trifluoroethyl methacrylate (n=1.418; Tg=69). These resins have a refractive index n of 1.42 or less, and especially 1.40 or less at which there is the effect on bringing surface reflectivity down expectable through low refraction.

The polymer has usually a number-average molecular weight of about 5,000 to 500,000 g/mole and a weight-average molecular weight of about 10,000 to 1,000,000 g/mole.

The aforesaid resin material, for instance, may be obtained by polymerizing and curing the above-exemplified monomer, etc. by any known process into a polymer. More specifically, reliance is upon a method wherein polymerization is carried out in the presence of a radical polymerization initiator, for instance, a method wherein a thermal polymerization initiator capable of generating radicals by heating is first added to a monomer composition, and the monomer composition is then polymerized by heating (hereinafter called also the thermal polymerization), and a method wherein a photo-polymerization initiator capable of generating radicals by irradiation with ultraviolet or other activating energy radiation is first added to a polymerizable composition, and the polymerizable composition is then polymerized by irradiation with activating energy irradiation (hereinafter called also the photo-polymerization). For the invention, the photo-polymerization is more preferred.

The addition of a thixotropy-imparting agent is also effective for facilitating the formation of convexity shape. The thixotropy-imparting agent here may be an inorganic fine particle having a large surface area. The fine particle powder added to this end is preferably an inorganic fine particle synthesized by gas phase reactions. For instance, there is the mention of fumed silica, fumed silica aluminum, and fumed titania. More specifically, use may be made of silica alumina (Aerosil MOX170), alumina (Aerooxide Alu C), titania (Aerooxide TiO2 P25), and zirconia (OZC-8YC made by Sumitomo Osaka Cement Co., Ltd or TZ-8Y made by Tosoh Corporation) or the like, which may be used alone or in combination of two or more, and usually added in an amount ranging from 0.1 to 10% by mass per the total amount of the starting resin, although optionally determined.

The staring composition may contain, in addition to the aforesaid thixotropy-imparting agent, various subordinate components inclusive of other monomers capable of radical polymerization, and additives such as antioxidants, ultraviolet absorbers, ultraviolet stabilizers, dyes and pigments, fillers, silane coupling agents, polymerization inhibitors, and light stabilizers. These subordinate components may be added, on occasion, in any desired amount and in a range having no adverse influences on the main components forming the resin.

The transparent resin layer, for instance, may be formed by polymerizing and curing a composition containing the exemplified monomer and polymer by any known process into a polymer and a copolymer. More specifically, reliance is upon a method wherein polymerization is carried out in the presence of a radical polymerization initiator, for instance, a method wherein a thermal polymerization initiator capable of generating radicals by heating is first added to a monomer composition, and the monomer composition is then polymerized by heating (hereinafter called also the thermal polymerization), and a method wherein a photo-polymerization initiator capable of generating radicals by irradiation with ultraviolet or other activating energy radiation is first added to a polymerizable composition, and the polymerizable composition is then polymerized by irradiation with activating energy radiation (hereinafter called also the photo-polymerization). For the invention, the photo-polymerization is more preferred.

The thermal polymerization initiator, for instance, includes hydrogen peroxide, benzoyl peroxide, diisopropyl peroxycarbonate, t-butyl peroxy(2-ethylhexanoate), and azo compounds such as 2,2′-azobisiso-butyronitrile, 4,4′-azobis(cyclohexanecarbonitrile), 4,4′-azobis(4-cyano-varelic acid), and 2,2′-azobis(2-methylpropane). Other commercial products such as Trigonox 21 and Perkadox 16, both being organic peroxides, may also be used as the initiator.

The aforesaid thermal polymerization initiators may be used alone or in admixture of two or more, and added in an amount of usually 0.01 to 20% by mass per the total amount of the monomers.

The photo-polymerization initiator, for instance, includes benzophenone, benzoin methyl ether, benzoin propyl ether, diethoxyacetophenone, 1-hydroxycyclohexyl phenyl ketone, 2,6-dimethylbenzoyl-diphenylphosphine oxide, 2,4,6-trimethylbenzoyldiphenyl phosphine oxide, 2-hydroxy-1-{4-[4-(2-hydroxy-2-methyl-propionyl)-benzyl phenyl}-2-methyl-propan-1-one, benzyl dimethyl ketal, 4-(2-hydroxyethoxy)phenyl-(2-hydroxy-2-propyl)ketone, and 2-methyl-2-morpholino(4-thiomethylphenyl)propan-1-one. Any desired photo-polymerization initiator may be used if it is a radical one; however, preference is given to 2-hydroxy-1-{4-[4-(2-hydroxy-2-methyl-propionyl)-benzyl phenyl}-2-methyl-propan-1-one (available in the trade name of Irgacure 127). Another requirement for this initiator is that it excellent in storage stability after blending.

The aforesaid photo-polymerization initiators may be used alone or in admixture of two or more, and may usually be added in an amount of 0.01 to 10% by mass per the total amount of the monomers. Too much photo-polymerization initiator may possibly trigger off rapid polymerization having adverse influences on optical characteristics, strength, etc., and too little may possibly give rise to insufficient polymerization of the starting composition.

The dose of the activating energy radiation may be optional if it allows the photo-polymerization initiator to generate radicals. However, all too little renders polymerization incomplete and, hence, makes the ensuing cured product poor in heat resistance and mechanical properties. All too much, on the contrary, causes the ensuing cured product to yellow or otherwise deteriorate due to light. Therefore, ultraviolet of, e.g., 200 to 400 nm in wavelength should preferably be applied in a dose of 0.1 to 200 J/cm² depending on the composition of the monomer and the type and amount of the photo-polymerization initiator. More preferably, the activating energy radiation should be applied in multiple doses. More specifically, if the first dose is set at about 1/20 to ⅓ of the total dose and the rest is applied in the required doses, then the ensuing cured product will have a much more reduced double refraction. The irradiation time may suitably be adjusted depending on the resin amount and the degree of curing. Usually, a selection may be made between about 1 second and about 10 minutes.

The light source used, for instance, may be LEDs (light emitting diodes) such as ultraviolet LED, blue LED and white LED, xenon lamps, carbon arcs, germicidal lamps, fluorescent lamps for ultraviolet, constant-pressure mercury lamps, high-pressure mercury lamps for copying, medium-pressure mercury lamps, high-pressure mercury lamps, super-high-pressure mercury lamps, electrodeless lamps, thallium lamps, indium lamps, metal halide lamps, xenon Lamps, excimer lamps made by Harison Toshiba Lighting Co., Ltd., and H bulbs, H plus bulbs, D bulbs, V bulbs, Q bulbs and M bulbs, all made by Fusion Co., Ltd. as well as sunlight. Furthermore, electron beams from scanning or curtain types of electron accelerating paths may be used. To achieve sufficient curing, activating energy radiations such as ultraviolet may be applied in an atmosphere of nitrogen or other inert gas.

For the purpose of finishing up polymerization rapidly, photo-polymerization and thermal polymerization may take place at the same time. In this case, the polymerizable composition may be heated and cured in a temperature range of 30 to 300° C. concurrently with irradiation with activating energy radiation. It is here to be noted that the thermal polymerization initiator may be added to the starting composition for the completion of polymerization; however, too much initiator may give rise to such adverse influences as mentioned above. Therefore, the thermal polymerization initiator should preferably be used in an amount of about 0.1 to 2% by mass per the total amount of the starting resin.

The starting composition may be used while dissolved in a solvent. There is no particular limitation on the solvent used: the optimum one may be used on occasion. Specifically, alcohol solvents such as alcohol and unsaturated alcohol or organic solvents may be used.

According to the invention, a primer layer may be formed between the aforesaid substrate and the fine convexity/concavity layer. The provision of the primer layer can improve the wettability of the substrate, and allows the substrate to have a greater angle of contact with a coating solution so that the coating solution can be placed in a state much closer to a hemisphere. It is also expected to improve the adhesion of the substrate to the fine convexity/concavity layer, and increase the refractive index of a site free of the convexity/concavity structure as well. As shown in FIG. 3, the protective sheet for photovoltaic apparatus is built up of a transparent substrate 301 and a primer layer 303 formed on the transparent substrate 301, with a fine convexity/concavity structure 302 provided on the primer layer 303.

Although there is no particular limitation on the primer layer, it should preferably be formed of a material having a large angle of contact with water in particular. More specifically, the angle of contact of that material should be larger than that of general glass) (30°, preferably 60° or greater, more preferably 70° or greater, and even more preferably 80° or greater. For such materials, for instance, use may be made of the resin material used for the aforesaid fine convexity/concavity structure, especially a fluorine-base resin, and more especially a fluorine-base acryl resin. This material is also preferable in view of adhesion to the fine convexity/concavity structure: it is most recommendable to make use of a material identical with or similar to that of the fine convexity/concavity structure.

The primer layer should preferably be as thin as possible, although not critical. That is, the thickness of the primer layer may be optimized depending on how to form it, the properties of the material used, the robustness and optical characteristics in demand, etc. Generally, the primer layer may have a thickness of about several hundred nm to several hundred μm for the purpose of improving wettability and adhesion, with the upper limit to it being about several millimeters.

The inventive protective sheet for photovoltaic apparatus may be produced by stacking or laminating on a transparent substrate located at a light reception site a transparent resin having a refractive index equal to or less than that of the transparent substrate, forming fine convexities/concavities on the surface of the transparent resin layer, and curing the transparent resin layer either during or after the formation of fine convexities/concavities so that there is a fine convexity/concavity structure formed on the surface of the transparent resin layer. More specifically, prior to the aforesaid curing, the transparent resin is applied on the surface of the transparent substrate by application means such as coating, printing or dipping into a transparent resin layer precursor. A mold or other member for the formation of convexities and concavities is then pressed against or otherwise engaged with that precursor. Then, the precursor is polymerized and cured by a given process into a transparent resin layer.

When the transparent resin is formed of the ultraviolet curing type resin, the transparent resin material comprising the ultraviolet curing type resin is first coated or otherwise laminated on the surface of the transparent substrate into the transparent resin layer precursor. Then, the mold having a fine convexity/concavity texture is pressed against or engaged with the transparent resin layer precursor, and simultaneously with or after that, ultraviolet is applied on that precursor to cure the transparent resin.

For the mold for the formation of the fine convexity/concavity structure, use may be made of various press molds such as molds used with printing or the like, although not critical. The mold here may be of plane shape or roll shape: it may be configured into shape well fitted for production processes. Such a mold, for instance, a sheet obtained by sintering glass cloth impregnated with Teflon (the registered trade mark) may be wound around a rubber or other roll to obtain a roll type mold.

With such a roll type mold, the fine convexity/concavity structure may be formed pursuant to printing techniques. More specifically, the mold is rolled on the transparent substrate with the transparent resin layer precursor formed on it, and simultaneously with that, ultraviolet is applied from the back side of the transparent substrate to cure the transparent resin. Alternatively, while that mold and ultraviolet generation means remain fixed, the transparent substrate with the transparent resin layer precursor laminated on it may be fed in between them.

Yet alternatively, the fine convexity/concavity structure may be formed by rotating a rigid member having multiple transverse grooves or convexities/concavities while it is engaged with the transparent resin layer precursor, or engaging a matrix of fine metal filaments or resin lines with the transparent resin layer precursor. It may also be formed by scraping or slicing off the surface of the transparent resin layer precursor with multiple claws or projections provided on the rigid member.

Furthermore, after the lamination of the aforesaid transparent resin, it may be provided with convexities/concavities by photo-masking or photo-molding. That is, when photo-masking is used, the photo-curing transparent resin is first formed into a film that is in turn masked with a photomask having a pattern matching the convexity/concavity pattern to be formed. Then, that pattern is irradiated with light or radiation or other energy radiation to cure the transparent resin at the convexities.

When photo-molding is used, curing may be implemented while the film-form resin is scanned with ultraviolet or energy radiation such as visible light laser, using devices such as a scanning mirror or XY plotter. In other words, the surface of the film-form resin is scanned and irradiated with the energy radiation following the convexity/concavity shape to cure the convexities, thereby forming convexities and concavities. If exothermic energy radiation such as infrared laser is used for irradiation, it is then possible to make use of the following thermosetting resin or thermoplastic resin.

When the transparent resin layer is formed of the thermosetting resin, fine convexities/concavities are provided on the transparent resin layer precursor as mentioned above and, simultaneously with or after that, it is heated to cure the transparent resin.

When the thermosetting resin is used, the mold wound around a metal roll having a heater may be rolled on the transparent substrate with the transparent resin layer precursor formed on it. Then, the heater is activated to apply heat to the thermosetting resin for setting. Alternatively, infrared radiation may be applied from the transparent substrate side in association with the rolling of the mold to give heat to the thermosetting resin for setting. Yet alternatively, while the aforesaid mold or the aforesaid mold and infrared generation means remain fixed, the transparent substrate with the transparent resin layer precursor laminated on it may be fed in between them.

When the transparent resin layer is formed of the thermoplastic resin, the thermoplastic resin that has been heated to lower its viscosity may be coated or otherwise applied to the surface of the transparent substrate to form the transparent resin layer precursor. Alternatively, the transparent resin dissolved in a solvent may be coated on the transparent substrate, and the solvent is then vaporized off to form the transparent resin layer.

When the thermoplastic resin is used, a roll type mold may be rolled on the transparent substrate with the transparent resin layer precursor formed on it, as is the case with the aforesaid thermosetting resin. Then, the heater is activated to thermally transform the thermoplastic resin thereby forming the convexity/concavity structure. Alternatively, infrared radiation may be applied from the transparent substrate side in association with mold pressing to give heat to the thermosetting resin for transformation. Yet alternatively, while the aforesaid mold remains fixed, the transparent substrate with the transparent resin layer precursor laminated on it may be fed in between them.

In the aforesaid process, the resin is cured or set while the resin layer is formed by coating or the like. In some cases, however, the resin layer may be cured or set after formed in such a way as to define a constant area. Best suited for continuous formation operation or fast resin layer formation is an ultraviolet curing type resin capable of being cured by ultraviolet irradiation. Other resins may be formed too, for instance, if they are dissolved in a solvent for coating, and then vaporized off.

The convexities/concavities may be formed not only by means of molds but also by means of printing processes such as screen printing, and offset printing. In this case, too, the resin layer may be cured or set either during or after printing.

Although there is no particular limitation on how to form the primer layer, it is preferable to make a suitable selection from among conventional coating processes. More specifically, it is preferable to use printing processes such as screen printing, gravure coating, reverse coating, bar coating, spray coating, knife coating, roll coating, and die coating, and although depending on the conditions involved, curtain coating (flow coating), spin coating, etc. may also be used.

According to the inventive process as described above, it is possible to provide a continuous production of the fine convexity/concavity structure, and make mass production much easier as well. Another merit is reduced production costs.

### EXAMPLES

### Example 1

First, 83 parts by weight of polyethylene glycol dimethacrylate (available from Shin-Nakamura Chemical Co., Ltd. in the trade name of NK Ester 4G) were mixed under agitation with 15 parts by weight of trifluoroethyl methacrylate (available from TOSOH•F-TECH, INC. in the trade name of Fluorester) and a titanocene type polymerization initiator (available from NOVARTIS in the trade name of Irgacure 784) into an ultraviolet curing resin.

Then, there was a Teflon sheet provided which was obtained by impregnating glass cloth with Teflon (trade name) and sintering them together. On the sheet surface, the mesh of glass cloth was embossed at a pitch of 200 μm and a depth of 50 μm. That Teflon sheet was then wound around a rubber roll to form a mold having 2,500 convexities/concavities per 1 cm².

Then, the ultraviolet curing resin was coated by means of a pipette near one side of a colorless sheet glass, after which the mold was pressed against the colorless sheet glass from the side with the resin coated on it and rolled toward the opposite side. Simultaneously, a high-pressure mercury lamp was located just below the mold with the colorless sheet glass sandwiched between them, and the resin was cured in association with mold pressing.

Examination was made of the properties of the colorless sheet glass on which the fine convexity/concavity texture formed of the transparent resin was provided as described above.

The cured product of the transparent resin used here had a refractive index of 1.47. Each or the convexity was of a quadrangular pyramid shape with slants making an angle of about 30 degrees with the colorless sheet glass plane. That cured product had a pencil hardness of 5H. All the surfaces (slants) of the thus obtained fine convexity/concavity texture made angles of 60 degrees or less with the normal to the substrate, and accounted for 100% of the whole convexity/concavity structure.

Light was entered at an angle of 45 degrees on the colorless sheet glass having a fine convexity/concavity texture formed on the surface in the example here. The quantity of refracted light was measured by a spectrophotometer for the purpose of a comparison with that of a colorless sheet glass with no texture formed on the surface. The quantity of transmitted light was 106 on the basis of 100—the quantity of light transmitted through the glass with no texture formed on it.

According to the invention, it has been found that the ultraviolet curing resin can be cured without being disturbed by oxygen because of the presence of the mold, and the curing speed increases about 20% as compared with that in the absence of the mold.

Further, even when the ultraviolet curing resin is made of a highly volatile component such as an acryl monomer, it can be cured without being vaporized off because of the presence of the mold: there could be processing carried out where there was no resin running short, and no air pollution, whatsoever.

Furthermore, the presence of the mold made sure substantial prevention of dirt entrapment, and the provision of a texture layer of high quality.

### Example 2

A plate for silk screen printing (having an aperture size of 30 to 100 μm) was used to print the ultraviolet curing resin of Example 1 on an acryl transparent film having a thickness of about 50 to 100 μm by means of conventional methods yet without recourse to any mask.

Consequently, it has been found that the ultraviolet curing resin is transferred just right according to the aperture pattern of the screen mesh. The height of the texture structure could be adjusted to several μm to several hundred μm by controlling plate thickness, resin viscosity, the solvent used and curing speed, and configured into a semicircular shape to a shape close to cone in section.

### INDUSTRIAL APPLICABILITY

The inventive protective sheet for photovoltaic apparatus is preferably used as a protective sheet having a coating layer for boosting up the light-collection efficiency of solar batteries. The inventive production process for protective sheets for photovoltaic apparatus enables a solar battery protective layer to be easily formed in simple operation, and that solar battery protective layer may also be applied to existing photovoltaic apparatus. The inventive protective sheet for photovoltaic apparatus is not limited to the types of power generation plates based on single crystals, poly-crystals, amorphous or other silicon semiconductors, CIGS or other compounds, and organic materials such as hue sensitizers or organic thin films: it may preferably be used with various types of solar batteries.

### EXPLANATION OF THE REFERENCE NUMERALS

1: Sheet
2: Transparent resin layer (having a convexity/concavity structure
101, 201: Transparent substrate
102, 202: Transparent resin layer with a fine convexity/concavity structure formed on it
103, 203: Mold for the fine convexity/concavity texture structure

What is claimed is:

1. A protective sheet for photovoltaic apparatus, comprising a transparent resin layer having a convexity/concavity structure on the surface of a transparent substrate located at a light reception site, wherein said transparent resin layer has a refractive index equal to or lower than that of said transparent substrate.

2. The protective sheet for photovoltaic apparatus according to claim 1, wherein said transparent substrate is formed of glass.

3. The protective sheet for photovoltaic apparatus according to claim 1, wherein said transparent resin layer is formed of either a resin or a resin and an inorganic material.

4. The protective sheet for photovoltaic apparatus according to claim 1, wherein a region, in which a tangent to a convex surface forming a part of said convexity/concavity structure makes an angle of 60 degrees or less with a normal to a substrate surface, has an area accounting for 5% or greater of a whole area of said convexity/concavity structure.

5. The protective sheet for photovoltaic apparatus according to claim 1, wherein said convexity/concavity structure is configured such that a sectional shape in a normal direction to said transparent substrate is approximate to either a part of a circle or a triangle wherein a bottom size is 200 nm to 1,000 μm as expressed in terms of diameter, and a convexities count is 1 to 2.5×10⁹ per 1 cm².

6. The protective sheet for photovoltaic apparatus according to claim 1, wherein said convexities and concavities have an average size of 2 mm or less.

7. The protective sheet for photovoltaic apparatus according to claim 1, wherein said transparent resin layer comprises a thermosetting resin or a photo-curing resin.

8. A process for producing a protective sheet for photovoltaic apparatus, comprising steps of:
stacking or laminating on a transparent substrate located at a light reception site a transparent resin having a refractive index equal to or lower than that of said transparent substrate,
configuring the surface of said transparent resin layer in such a way as to have fine convexities and concavities, and
curing said transparent resin layer either during or after said configuring so that a structure having fine convexities/concavities is formed on the surface of said transparent resin layer.

9. The protective sheet production process according to claim 8, wherein the surface of said transparent resin layer is pressed against a combination of a mold having fine convexities/concavities and a thread-form member or continuously engaged with or scraped off by a rigid member having projections or claws to form concavities, thereby providing a convexity/concavity texture.

10. The protective sheet production process according to claim 8, wherein after lamination of said transparent resin, convexities/concavities are provided by means of photo-masking or photo-molding.

11. The protective sheet production process according to claim 8, wherein said transparent resin is laminated by printing in a pattern having fine convexities/concavities to provide a convexity/concavity structure thereto.

12. The protective sheet production process according to claim 8, wherein said transparent resin layer comprises a thermosetting resin or a photo-curing resin.
